(19) United States
(12) Patent Application Publication
(10) Pub. No.: US 2018/0276733 A1
(43) Pub. Date: Sep. 27, 2018

(54) INFORMATION PROCESSING APPARATUS

(71) Applicant: FUJI XEROX CO., LTD., Tokyo (JP)

(72) Inventors: Takashi SONODA, Kanagawa (JP); Masahiro SATO, Kanagawa (JP)

(73) Assignee: FUJI XEROX CO., LTD., Tokyo (JP)

(21) Appl. No.: 15/918,500

(22) Filed: Mar. 12, 2018

(30) Foreign Application Priority Data
Mar. 24, 2017 (JP) 2017-059234

(51) Int. Cl. G06Q 30/06

(52) U.S. Cl. CPC G06Q 30/0631; G06Q 30/0641

(57) ABSTRACT

An information processing apparatus includes a first acquisition unit, a second acquisition unit, an evaluation unit, and an output unit. The first acquisition unit acquires first information indicating groups of plural articles. The second acquisition unit acquires second information indicating purchase histories of the respective articles. The evaluation unit evaluates, for each group, a relationship between the articles based on the purchase histories of the articles. The output unit performs output in accordance with the evaluation by the evaluation unit.

### CROSS-REFERENCE TO RELATED APPLICATIONS

This application is based on and claims priority under 35 USC 119 from Japanese Patent Application No. 2017-059234 filed Mar. 24, 2017.

### BACKGROUND

### Technical Field

The present invention relates to an information processing apparatus.

### SUMMARY

According to an aspect of the invention, an information processing apparatus includes a first acquisition unit, a second acquisition unit, an evaluation unit, and an output unit. The first acquisition unit acquires first information indicating groups of plural articles. The second acquisition unit acquires second information indicating purchase histories of the respective articles. The evaluation unit evaluates, for each group, a relationship between the articles based on the purchase histories of the articles. The output unit performs output in accordance with the evaluation by the evaluation unit.

### BRIEF DESCRIPTION OF THE DRAWINGS

Exemplary embodiments of the present invention will be described in detail based on the following figures, wherein:

FIG. 1 is a diagram illustrating an overall configuration of an information processing system according to an exemplary embodiment;

FIG. 2 is a diagram illustrating an example of the configuration of a terminal;

FIG. 3 is a diagram illustrating the configuration of an information processing apparatus;

FIG. 4 is a diagram for explaining the classification of articles stored in an article DB;

FIGS. 5A to 5C are diagrams illustrating an example of databases stored in a memory unit;

FIG. 6 is a diagram illustrating the functional configuration of the information processing apparatus;

FIG. 7 is a flowchart for explaining the flow of an operation of the information processing apparatus;

FIG. 8 is a diagram for explaining an example of correction of a purchase history;

FIG. 9 is a diagram for explaining a period during which two sales periods overlap each other; and

FIGS. 10A to 10C are diagrams for explaining a relationship between two articles.

### DETAILED DESCRIPTION

### 1. Exemplary Embodiment

1-1. Overall Configuration of Information Processing System

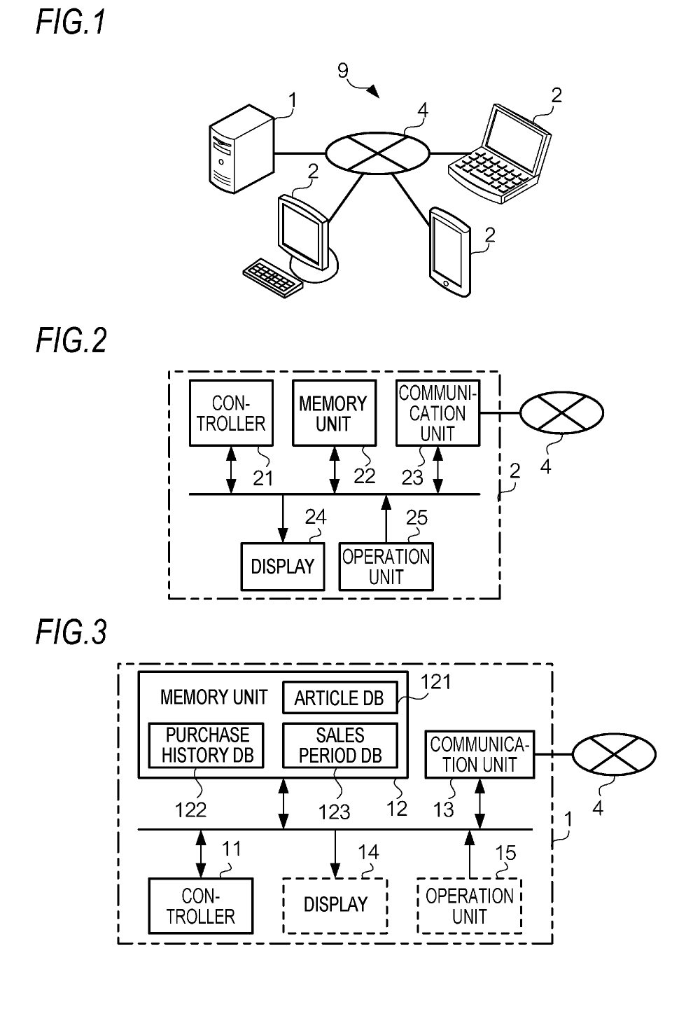

FIG. 1 is a diagram illustrating the overall configuration of an information processing system 9 according to a present exemplary embodiment. The information processing system 9 includes a communication line 4 which forms a local area network (LAN), a wide area network (WAN), or the like and an information processing apparatus 1 and terminals 2 which are connected to the communication line 4.

Each terminal 2 shown in FIG. 1 is a terminal provided in a store (hereinafter, referred to as a “real store”) that sales commodities to a customer who visits there without a communication network such as the Internet. The terminal 2 is connected to, for example, a cash register used in the real store. The terminal 2 manages data such as the types and number of articles purchased by customers and transmits the data to the information processing apparatus 1. The information processing system 9 may include multiple terminals 2 as illustrated in FIG. 1 or may include a single terminal 2.

The information processing apparatus 1 illustrated in FIG. 1 receives the above-described data from the terminal 2 and outputs information useful to determine, for example, advertisement, display mode, arrangement and the like of articles based on the data. The information processing system 9 may include a single information processing apparatus 1 as illustrated in FIG. 1, or may include multiple information processing apparatuses 1.

1-2. Configuration of Terminal

FIG. 2 is a diagram illustrating an example of the configuration of the terminal 2. The terminal 2 includes a controller 21, a memory unit 22, a communication unit 23, a display 24, and an operation unit 25.

The controller 21 includes a central processing unit (CPU), a read only memory (ROM), and a random access memory (RAM). The CPU reads and executes computer programs (hereinafter simply referred to as programs) stored in the ROM and the memory unit 22, thereby controlling the respective units of the terminal 2.

The memory unit 22 is a large-capacity memory unit such as a solid state drive or a hard disk drive, and stores various programs to be read by the CPU of the controller 21.

The communication unit 23 is a communication circuit that is connected to the communication line 4 in a wireless or wired manner. The terminal 2 exchanges information with the information processing apparatus 1 via the communication line 4 by the communication unit 23 thereof.

The operation unit 25 includes an operator such as an operation button for giving various instructions. The operation unit 25 receives an operation by a user and supplies a signal corresponding to an operation content to the controller 21. In addition, the operation unit 25 may include a touch panel which detects the contact, pressure, or the like of an operation body such as a user's finger or a stylus pen.

The display 24 includes a liquid crystal display, and displays an image under the control of the controller 21. The transparent touch panel of the operation unit 25 may be disposed to overlap the liquid crystal display of the display 24.

1-3. Configuration of Information Processing Apparatus

FIG. 3 is a diagram illustrating the configuration of the information processing apparatus 1. The information processing apparatus 1 includes a controller 11, a memory unit 12, and a communication unit 13. In addition, the information processing apparatus 1 may include a display 14 and an operation unit 15 which are illustrated by broken lines in FIG. 3.

The controller 11 includes a CPU, a ROM, and a RAM. The CPU reads and executes programs stored in the ROM and the memory unit 12, thereby controlling the respective units of the information processing apparatus 1.

The communication unit 13 is a communication circuit that is connected to the communication line 4 in a wireless or wired manner. The information processing apparatus 1 exchanges information with the terminal 2 via the communication line 4 by the communication unit 13 thereof.

The operation unit 15 includes an operator such as an operation button for giving various instructions. The operation unit 15 receives an operation by a user and supplies a signal corresponding to the operation content to the controller 11. In addition, the operation unit 15 may include a touch panel which detects an operation body such as a user's finger or a stylus pen.

The display 14 includes a display screen such as a liquid crystal display, and displays an image under the control of the controller 11. The transparent touch panel of the operation unit 15 may be disposed to overlap the display screen of the display 14.

The memory unit 12 is a large-capacity memory unit such as a hard disk drive, and stores various programs to be read by the CPU of the controller 11. In addition, the memory unit 12 stores an article DB 121, a purchase history DB 122, and a sales period DB 123.

The article DB 121 is a database that stores information on articles such as article identification information and classification of the articles. The purchase history DB 122 is a database that stores a history (purchase history) indicating when an article was purchased. The sales period DB 123 is a database that stores a period (sales period) during which an article has been sold.

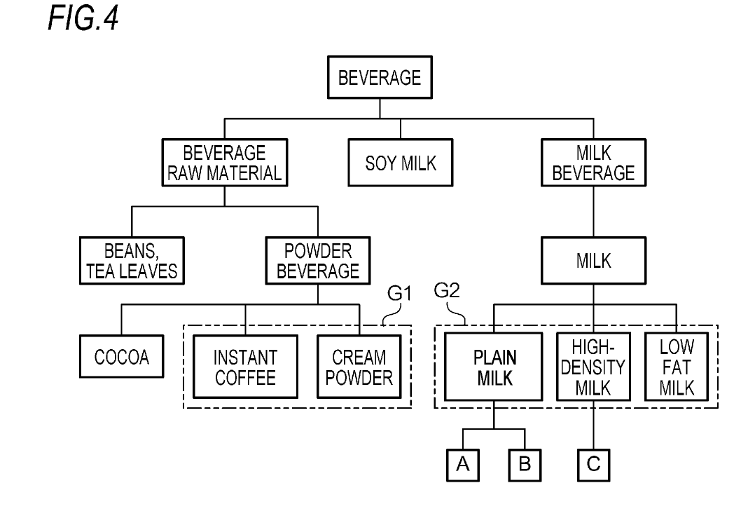

FIG. 4 is a diagram for explaining the classification of articles stored in the article DB 121. The article DB 121 is a database that stores various kinds of information such as classification and unit price with regard to articles purchased by users in a real store. As illustrated in FIG. 4, for example, articles are classified into multiple levels such as a category, a sub-category, a sub-sub-category, and a sub-sub-sub-category. One category includes one or multiple sub-categories. One sub-category includes one or multiple sub-sub-categories. One sub-sub-category includes one or multiple sub-sub-sub-categories. In addition, one sub-sub-sub-category includes one or multiple articles. That is, in the example illustrated in FIG. 4, the classification of articles (article classification) is determined by combinations of categories, sub-categories, sub-sub-categories, and sub-sub-sub-categories.

An example of a category illustrated in FIG. 4 is a “beverage” or the like. In addition, examples of sub-categories are “beverage raw material,” “soy milk,” “milk beverage,” and the like. In addition, examples of sub-sub-categories are “beans/tea leaves,” “powder beverage,” “milk,” and the like. In addition, examples of sub-sub-sub-categories are “cocoa,” “instant coffee,” “cream powder,” “plain milk,” “high-density milk,” “low fat milk,” and the like. In addition, for example, in the example illustrated in FIG. 4, both of an article “A” and an article “B” belong to “plain milk” of the sub-sub-sub-category.

A group G1 illustrated in FIG. 4 indicates a group including “instant coffee” and “cream powder.” When the user purchases “instant coffee,” the user does not have to purchase “cream powder.” On the other hand, when the user purchases “cream powder,” a rate at which “instant coffee” is purchased together is relatively high. “Instant coffee” is sometimes used alone without using “cream powder,” but “cream powder” is relatively unlikely to be used alone without “instant coffee.”

Here, this relationship of the group G1 is referred to as a “relationship having complementarity.” “Cream powder” is an article that complements “instant coffee” premised on the presence of “instant coffee,” that is, a complementary article of “instant coffee.”

In addition, a group G2 illustrated in FIG. 4 indicates a group including “plain milk,” “high-density milk,” and “low fat milk.” When a user purchases one of these articles, a rate at which the user purchases another one of these articles decreases. This is because these articles have similar uses, and when one of these articles is selected, it is not necessary to use another one of these articles in many cases.

Here, this relationship in the group G2 is referred to as a “substitutional relationship.” “Plain milk,” “high-density milk,” and “low fat milk” are referred to mutually substitutive articles.

The information processing apparatus 1 specifies, for each group of two or more articles, in what manner the articles belonging to each group are purchased using the databases stored in the memory unit 12 and evaluates a relationship between the articles.

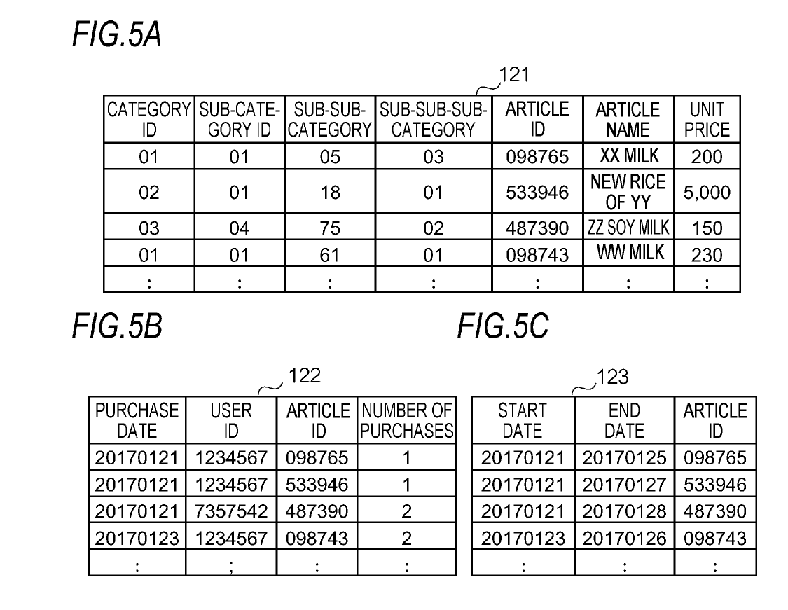

FIGS. 5A to 5C are diagrams illustrating an example of the databases stored in the memory unit 12. FIG. 5A illustrates an example of the article DB 121. As illustrated in FIG. 5A, the article DB 121 stores each article ID which is identification information for identifying an article in association with an article category. In addition, as illustrated in FIG. 5A, the article DB 121 may store, for each article ID, an article name which is the name of an article and a unit price which is the price of the article in association with each other.

For example, the article DB 121 illustrated in FIG. 5A stores that an article Identified by an article ID “098765” is classified into a category ID “01,” a sub-category ID “01,” a sub-sub-category ID “05,” and a sub-sub-sub-category ID “03,” that an article name thereof is “XX milk” and that the unit price thereof is “200.”

FIG. 5B illustrates an example of the purchase history DB 122. As illustrated in FIG. 5B, the purchase history DB 122 stores, for each article ID of a purchased article, date (purchase date) at which the article was purchased and the number of purchased articles (number of purchases) in association with each other. In addition, in the example illustrated in FIG. 5B, the purchase history DB 122 stores a user ID which is identification information of a user who purchased the article in association with each article ID of the purchased article. In addition, the purchase date may include information indicating a time.

For example, the purchase history DB 122 illustrated in FIG. 5B stores that the article Identified by the article ID “098765” was purchased on the purchase date “20170121” by the user identified by the user ID “1234567” with the number of purchases “1.”

FIG. 5C illustrates an example of the sales period DB 123. As illustrated in FIG. 5C, the sales period DB 123 stores, for each article ID, a sales period of the article indicated by the article ID. The sales period refers to a period from a start date at which sales was started to an end date at which sales was ended. “Sales was ended” also includes a case where all stocks were purchased and no article remains in a real store, in addition to a case where articles are recovered from the store while stocks are present. That is, an article may be purchased within the sales period thereof, but may not be purchased for a period rather than the sales period. In addition, the start date and the end date may include information indicating a time.

For example, the sales period DB 123 illustrated in FIG. 5C stores that the article identified by the article ID “098765” was sold from the start date “20170121” to the end date “20170125.”

1-4. Functional Configuration of Information Processing Apparatus

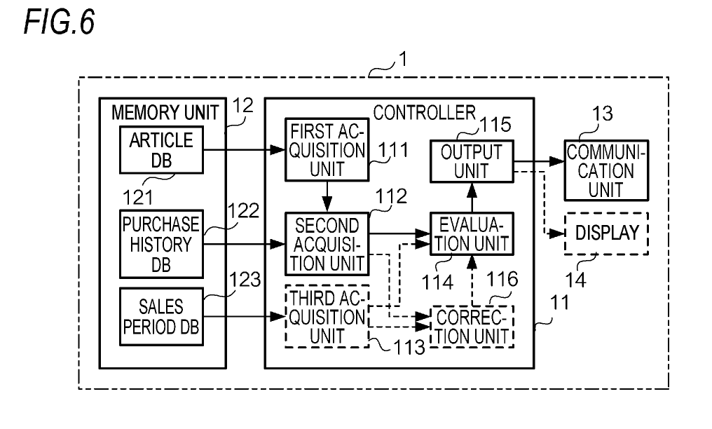

FIG. 6 is a diagram illustrating a functional configuration of the information processing apparatus 1. The controller 11 of the information processing apparatus 1 illustrated in FIG. 6 serves as a first acquisition unit 111, a second acquisition unit 112, an evaluation unit 114, and an output unit 115 by executing the programs stored in the memory unit 12. In addition, as illustrated by broken lines in FIG. 6, the controller 11 may serve as a third acquisition unit 113 and a correction unit 116.

The first acquisition unit 111 acquires first information indicating groups of multiple articles from the article DB 121 stored in the memory unit 12. The number of articles constituting a group may be two or may be three or more as long as the articles are plural different articles. The first acquisition unit 111 may acquire, for example, all groups of two articles among the articles stored in the article DB 121. In addition, the groups of articles acquired by the first acquisition unit 111 may be article category groups.

The second acquisition unit 112 acquires second information indicating purchase histories of the respective multiple articles from the purchase history DB 122 stored in the memory unit 12.

The evaluation unit 114 evaluates, for each group indicated by the first information acquired by the first acquisition unit 111, a relationship between the articles based on the purchase histories of the respective articles. The evaluation unit 114 illustrated in FIG. 6 evaluates the relationship based on a rate at which when one of articles included in a group is purchased, another article included in the group is purchased. In the case where the first acquisition unit 111 acquires article category groups, the evaluation unit 114 evaluates, for each of the article category groups, a relationship between article categories included in the group.

In addition, the second acquisition unit 112 may acquire second information indicating a purchase history for each user. In this case, the controller 11 may serve as the correction unit 116 which specifies multiple users having similar article purchase histories based on the acquired second information and corrects the above-described second information for these users. Then, the evaluation unit 114 may evaluate a relationship between the above-described articles based on the corrected second information.

The output unit 115 performs output in accordance with the evaluation by the evaluation unit 114. For example, the output unit 115 may output, for each group of articles, information indicating which article included in the group is superior. In addition, the output unit 115 may output, based on the superiority and inferiority of articles included in a group, information indicating the display mode, arrangement, quantity, advertisement layout of the articles in a real store, the timing and frequency of voice guidance in the store, and the like.

The third acquisition unit 113 acquires third information indicating periods during which the respective multiple articles were sold. When the controller 11 serves as the third acquisition unit 113, the evaluation unit 114 specifies, using the third information acquired by the third acquisition unit 113, a period during which all of the multiple articles included in the groups which are indicated by the first information acquired by the first acquisition unit 111 were sold. Then, the evaluation unit 114 may evaluate a relationship between the articles based on the purchase histories of the articles in the specified period.

1-5. Operation of Information Processing Apparatus

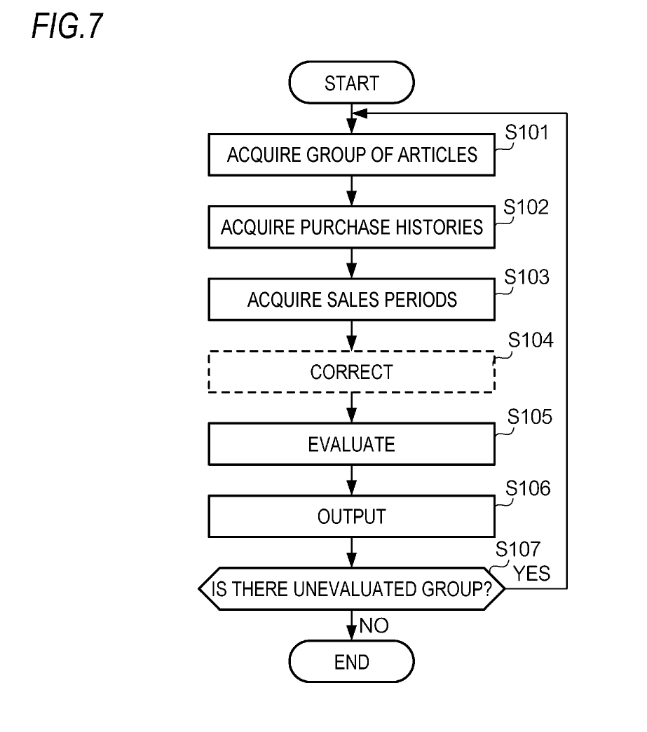

FIG. 7 is a flowchart illustrating the flow of an operation of the information processing apparatus 1. The controller 11 of the information processing apparatus 1 acquires first information indicating a group of multiple articles from the article DB 121 (step S101). In addition, the controller 11 acquires second information indicating purchase histories of the respective multiple articles (step S102). In addition, the controller 11 acquires third information indicating sales periods for which the respective multiple articles (step S103). The processes from step S101 to step S103 may be performed in any order or may be performed in parallel.

When the controller 11 serves as the above-described correction unit 116, the controller 11 specifies multiple users having similar article purchase histories by, for example, a collaborative filtering method based on the second information acquired in step S102. This similarity determination may be made based on, for example, a Euclidean distance between multidimensional vectors indicated by respective purchase histories of the users. Then, the controller 11 corrects a purchase history based on the purchase histories of the specified similar users (step S104).

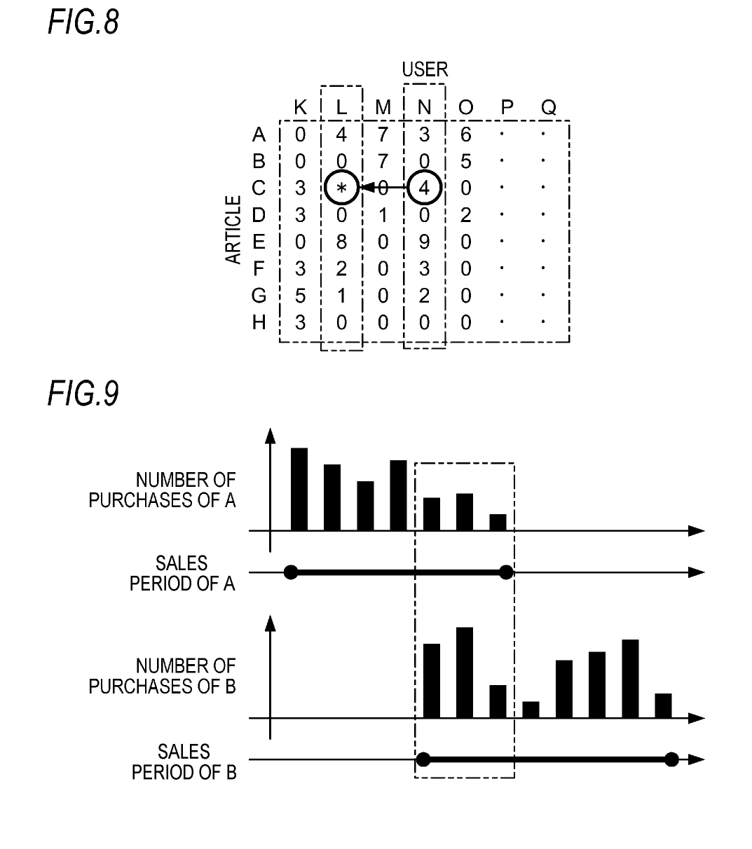

FIG. 8 is a diagram for explaining an example of the correction of the purchase history. FIG. 8 shows amounts of articles from “A” to “H” that the users from “K” to “Q” purchased within a predetermined period. The controller 11 determines that the purchase histories of the user “L” and the user “N” are similar to each other by the collaborative filtering method, and specifies both of the user “L” and the user “H” as similar users.

Subsequently, the controller 11 specifies a difference between the respective purchase histories of the user “L” and the user “N.” In the example illustrated in FIG. 8, the user “N” purchased four article “C”, whereas the user “L” purchased no article “C.” Users having similar purchase histories often have a common preference, interest, life pattern, or the like. Therefore, the user “L” having the purchase history similar to that of the user “N” has a high possibility of purchasing the article “C,” like the user “N.”

Therefore, the controller 11 makes a correction to replace the purchase history used for the evaluation by data corresponding to a case where the user “L” purchases the article “C,” for example, at the same level as the user “N.” Thereby, the information processing apparatus 1 excludes the difference from another user having a similar purchase history as an abnormal value. Therefore, for example, the prediction of a future purchase behavior is corrected for an article that has never been purchased due to the lack of knowledge or experience of the user, but is highly likely to be purchased (so-called a “thoughtlessly avoided” article) when there is a chance.

In addition, the number of purchases may be corrected based on a statistical representative value such as the arithmetic mean, mode, or intermediate value of the number of purchases of multiple users having similar purchase histories. In this case, data to be corrected may be specified based on whether or not the difference from the statistical representative value exceeds a threshold value.

As illustrated in FIG. 7, the controller 11 evaluates a relationship between the articles included in the group based on the corrected purchase history and the acquired sales period (step S105). The controller 11 aggregates and evaluates the purchase histories for a period during which the respective sales periods of the multiple articles included in the group overlap each other.

FIG. 9 is a diagram for explaining a period during which two sales periods overlap each other. In FIG. 9, the number of purchases and the sales period of each of the article “A” and the article “B” are illustrated. The article “A” and the article “B” have different sales periods. Therefore, for example, for a period during which only the article “A” was sold and the article “B” was not sold, a user cannot purchase the article “B” even if the user is willing to purchase the article “B.” Thus, when evaluating the group of the article “A” and the article “B,” the controller 11 uses the number of purchases for a period during which both of the article “A” and the article “B” were sold. With this configuration, for example, the information processing apparatus 1 distinguishes an article which was sold but was not purchased, from an article which was not sold and thus was not purchased.

When evaluating the group of the article “A” and the article “B,” the controller 11 performs evaluation based on the purchase histories thereof for the period during which the respective sales periods thereof overlap each other.

For example, the controller 11 calculates a rate of the number of accounts in which the article “A” was purchased among accounts performed for the above-described period, as a probability P(A₁) of the article “A” being purchased. Specifically, the controller 11 calculates, as the probability P(A₁), a numerical value obtained by dividing the number of accounts in which the article “A” was purchased by the total number of accounts for this period. In this case, the probability P(A₀) of the article “A” being not purchased is indicated by the following formula (1).

P(A₀)=1−P(A₁) (1)

Here, the “number of accounts” may be obtained by regarding accounts performed by a common user for a fixed period such as within 2 hours or for the same day as one account.

The controller 11 calculates a probability P(B₁) of the article “B” being purchased and a probability P(B₀) of the article “B” being not purchased.

In addition, the controller 11 calculates a probability P(A₁, B₀) of the article “A” being purchased and the article “B” being not purchased. Specifically, the controller 11 calculates the probability P(A₁, B₀) by obtaining the rate of the number of accounts in which the article “A” is purchased and the article “B” is not purchased among accounts performed for the above-described period.

Then, the controller 11 calculates a probability P(A₀, B₁) of the article “A” being not purchased and the article “B” being purchased and a probability P(A₁, B₁) of the article “A” being purchased and the article “B” being purchased.

The controller 11 obtains mutual information amount I(A, B) indicated by the purchase histories of the article “A” and the article “B,” using the calculated probabilities. The mutual information amount I(A, B) is represented by the following formula (2).

$$I ( A , B ) = {\sum }_{i , j} P ( {A}_{i} , {B}_{j} ) {log}_{2} \frac{P ( {A}_{i} , {B}_{j} )}{P ( {A}_{i} ) P ( {B}_{j} )} \qquad ( 2 )$$

In the formula (2), subscripts i and j represent “not purchased” in the case of “0” and “purchased” in the case of “1.”

The mutual information amount I(A, B) represents how much information on the other article (here, assumed as the article “B”) is known when it is found that one article (here, assumed as the article “A”) is purchased. That is, a pair of articles having a low mutual information amount is a highly independent article pair, and the purchase of one article has no effect on the purchase of the other article. On the other hand, for an article pair having a high mutual information amount, the purchase of one article has an effect on the purchase of the other article. The effect at this time includes a case where the other article is always purchased when one article is purchased and a case where the other article is never purchased when one article is purchased.

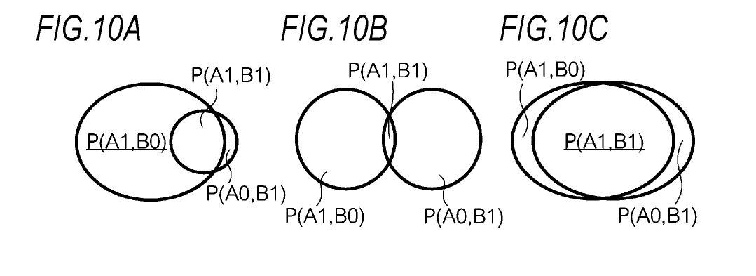

In addition, the controller 11 evaluates a relationship between the article “A” and the article “B” based on a relative rates of the mutual information amount I(A, B), the probability P(A₁, B₀), the probability P(A₀, B₁), and the probability P(A₁, B₁). FIGS. 10A to 10C are diagrams for explaining a relationship between two articles. In the example illustrated in FIG. 10A, an information amount possessed by the article “B” and the mutual information amount are approximately the same. At this time, the probability P(A₁, B₀) is larger than the probability P(A₁, B₁), and the probability P(A₀, B₁) is remarkably smaller than the both. This means that the article “A” is also generally purchased when the article “B” is purchased.

In this case, the controller 11 compares these rates with a predetermined threshold value, determines that the article “A” and the article “B” are in a “relationship having complementarity,” and rates the article “B” as a complementary article of the article “A.”

In addition, in the example illustrated in FIG. 10B, the purchase of two articles has no dependence relationship with each other, and therefore the mutual information amount has a low value. At this time, the probability P(A₁, B₀) and the probability P(A₀, B₁) are approximately equal to each other, and the probability P(A₁, B₁) is remarkably smaller than the both. This means that the article “A” is hardly purchased when the article “B” is purchased, while the article “B” is hardly purchased when the article “A” is purchased. That is, one of the article “A” and the article “B” is selectively purchased.

In this case, the controller 11 compares these rates with the predetermined threshold value, determines that the article “A” and the article “B” are in a “relationship having substitutivity,” and rates the article “A” and the article “B” as mutually substitutive articles.

In addition, in the example illustrated in FIG. 10C, the purchase of two articles have a dependence relationship with each other. Thus, the mutual information amount has a high value. At this time, the probability P(A₁, B₀) and the probability P(A₀, B₁) are approximately equal to each other, and the probability P(A₁, B₁) is remarkably larger than the both. This means that the article “A” and the article “B” are purchased together in most cases. That is, the article “A” and the article “B” form a group of articles which are purchased at the same time.

In this case, the controller 11 compares the rates of these with the predetermined threshold value, determines that the article “A” and the article “B” are in a “relationship having simultaneity,” and rates the article “A” and the article “B” as articles that are likely to be purchased at the same time.

Based on the comparison of the mutual information amount I(A, B) and the probabilities described above, the controller 11 evaluates, for each group of articles, a relationship between the articles included in the group and outputs the evaluation result (step S106). Then, the controller 11 determines whether or not there exists an unevaluated group (step S107). If determining that there exists an unevaluated group, the controller 11 returns the process to step S101 (step S107; YES). On the other hand, if determining that there exists no unevaluated group (step S107; NO), the controller 11 terminates the process.

With the above operation, the information processing apparatus 1 of the information processing system 9 evaluates, for each group of articles, a relationship between the articles based on the respective purchase histories of the articles. Thus, the user determines, for example, which article is to be advertised or displayed conspicuously in consideration of the mutual influence of multiple articles on the purchase behaviors of customers.

For example, if a rate at which the article “B” (second article) is purchased when the article “A” (first article) is purchased is larger by more than a threshold value than a rate at which the article “A” (first article) is purchased when the article “B” (second article) is purchased, the information processing apparatus 1 determines that the article “A” (first article) and the article “B” (second article) are in a “relationship having complementarity” and rates the article “B” (second article) as a complementary article of the article “A” (first article).

At this time, the information processing apparatus 1 rates the article “B” (second article) as being superior to the article “A” (first article), and proposes, for example, a sales plan in which the article “B” (second article) is advertised or displayed more conspicuously than the article “A” (first article).

In addition, when handling a new article, the user may specify an article category of the new article and may determine a method of advertising or displaying the new article based on a relationship between the new article and an existing article which is evaluated by the information processing apparatus 1 for each article category group.

### 2. Modification

The exemplary embodiment has been described above. The contents of the exemplary embodiment may be modified as follows. In addition, the following modifications may be combined with each other.

2-1. Modification 1

In the above-described exemplary embodiment, the information processing apparatus 1 of the information processing system 9 stores the article DB 121, the purchase history DB 122, and the sales period DB 123 in the memory unit 12. These databases may be managed by a server device other than the information processing apparatus 1. In this case, the information processing apparatus 1 may transmit a query requesting data to the server device via the communication line 4, and the server device may supply data corresponding to the query. In addition, these databases may not be generated by accumulating information transmitted from the terminal 2, but may be generated, for example, by a user's operation in the server device or in the information processing apparatus 1. In this case, the information processing system 9 may not include the terminal 2.

2-2. Modification 2

In the above-described exemplary embodiment, the evaluation unit 114 implemented by the controller 11 of the information processing apparatus 1 evaluates the relationship based on the rate at which when one of articles included in a group is purchased, another article included in the group is purchased. It should be noted that the evaluation unit is not limited to this example. For example, in a case where three or more articles are included in a group, when one article included in the group is purchased and another article among the other articles included in the group is further purchased, the evaluation unit 114 may evaluate a relationship between the three or more articles based on a rate at which an article which is included in the group but is not any of the above described articles is purchased.

2-3. Modification 3

In the above-described exemplary embodiment, when the controller 11 of the information processing apparatus 1 serves as the third acquisition unit 113 which acquires third information indicating the sales periods of the multiple articles, the controller 11 serves as the evaluation unit 114 which evaluates the relationship between the articles based on the purchase histories of the articles for the period during which the sales periods of multiple articles included in the group overlap each other. Alternatively, the controller 11 may evaluate the relationship without considering the sales periods. In this case, the controller 11 may not serve as the third acquisition unit 113, and the memory unit 12 may not store the sales period DB 123.

2-4. Modification 4

In the above-described exemplary embodiment, the controller 11 corrects the purchase history based on the purchase histories of the specified similar users. Alternatively, the controller 11 may not make this correction and may not specify users having similar purchase histories.

2-5. Modification 5

In the above-described exemplary embodiment, the evaluation unit 114 implemented by the controller 11 of the information processing apparatus 1 evaluates the relationship between the first article and the second article as the second article being superior to the first article, if a rate at which the second article is purchased when the first article is purchased is larger by more than the threshold value than a rate at which the first article is purchased when the second article is purchased. It should be noted that an evaluation unit is not limited thereto.

For example, if the rate at which the first article and the second article are purchased at the same time is larger by more than the predetermined threshold value than a rate at which only one of the first and second articles is purchased, the controller 11 may propose a sales plan in which a third article which is neither the first article nor the second article is recommended to the user. This is because, when there is a high possibility of the first article and the second article being purchased together, it is predicted that there is no change in the number of purchases even if one of the first article and the second article is recommended.

In addition, for example, if a rate at which only one of the first article and the second article is purchased is larger by more than a predetermined threshold value than a rate at which the first article and the second article are purchased at the same time, the controller 11 may propose a sales plan in which one of the first article and the second article is randomly selected and is recommended to the user. The first article and the second article are in a relationship having substitutability. Therefore, even if one of the first article and the second article is purchased in response to the recommendation, there is a low possibility that the other is purchased.

2-6. Modification 6

A program executed by the controller 11 of the information processing apparatus 1 may be provided in a state in which it is stored in a computer-readable recording medium including a magnetic recording medium such as a magnetic tape or a magnetic disc, an optical recording medium such as an optical disc, a magneto-optical recording medium, a semiconductor memory or the like. In addition, the program may be downloaded via a communication line such as the Internet. In addition, as a control device exemplified by the controller 11 described above, various devices other than the CPU may be applied, and for example, a dedicated processor or the like is used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first acquisition unit that acquires first information indicating groups of a plurality of articles;
a second acquisition unit that acquires second information indicating purchase histories of the respective articles;
an evaluation unit that evaluates, for each group, a relationship between the articles based on the purchase histories of the articles; and
an output unit that performs output in accordance with the evaluation by the evaluation unit.

2. The information processing apparatus according to claim 1, wherein the evaluation unit evaluates the relationship based on a rate at which when one of the articles included in one of the groups is purchased, another article included in the one of the groups is purchased.

3. The information processing apparatus according to claim 1, further comprising:
a third acquisition unit that acquires third information indicating periods during which the respective articles were sold,
wherein the evaluation unit evaluates the relationship based on the purchase histories of the articles in a period during which all of the plurality of articles were sold.

4. The information processing apparatus according to claim 2, further comprising:
a third acquisition unit that acquires third information indicating periods during which the respective articles were sold,
wherein the evaluation unit evaluates the relationship based on the purchase histories of the articles in a period during which all of the plurality of articles were sold.

5. The information processing apparatus according to claim 1, wherein
the second acquisition unit acquires the second information indicating the history for each user, and
the evaluation unit evaluates the relationship using the second information which is corrected for a plurality of users having similar purchase histories.

6. The information processing apparatus according to claim 2, wherein
the second acquisition unit acquires the second information indicating the history for each user, and
the evaluation unit evaluates the relationship using the second information which is corrected for a plurality of users having similar purchase histories.

7. The information processing apparatus according to claim 3, wherein
the second acquisition unit acquires the second information indicating the history for each user, and
the evaluation unit evaluates the relationship using the second information which is corrected for a plurality of users having similar purchase histories.

8. The information processing apparatus according to claim 4, wherein
the second acquisition unit acquires the second information indicating the history for each user, and
the evaluation unit evaluates the relationship using the second information which is corrected for a plurality of users having similar purchase histories.

9. The information processing apparatus according to claim 1, wherein when a rate at which a second article is purchased when a first article is purchased is larger by more than a threshold value than a rate at which the first article is purchased when the second article is purchased, the evaluation unit rates the relationship as the second article being superior to the first article.

10. The information processing apparatus according to claim 2, wherein when a rate at which a second article is purchased when a first article is purchased is larger by more than a threshold value than a rate at which the first article is purchased when the second article is purchased, the evaluation unit rates the relationship as the second article being superior to the first article.

11. The information processing apparatus according to claim 3, wherein when a rate at which a second article is purchased when a first article is purchased is larger by more than a threshold value than a rate at which the first article is purchased when the second article is purchased, the evaluation unit rates the relationship as the second article being superior to the first article.

12. The information processing apparatus according to claim 4, wherein when a rate at which a second article is purchased when a first article is purchased is larger by more than a threshold value than a rate at which the first article is purchased when the second article is purchased, the evaluation unit rates the relationship as the second article being superior to the first article.

13. The information processing apparatus according to claim 5, wherein when a rate at which a second article is purchased when a first article is purchased is larger by more than a threshold value than a rate at which the first article is purchased when the second article is purchased, the evaluation unit rates the relationship as the second article being superior to the first article.

14. The information processing apparatus according to claim 6, wherein when a rate at which a second article is purchased when a first article is purchased is larger by more than a threshold value than a rate at which the first article is purchased when the second article is purchased, the evaluation unit rates the relationship as the second article being superior to the first article.

15. The information processing apparatus according to claim 7, wherein when a rate at which a second article is purchased when a first article is purchased is larger by more than a threshold value than a rate at which the first article is purchased when the second article is purchased, the evaluation unit rates the relationship as the second article being superior to the first article.

16. The information processing apparatus according to claim 8, wherein when a rate at which a second article is purchased when a first article is purchased is larger by more than a threshold value than a rate at which the first article is purchased when the second article is purchased, the evaluation unit rates the relationship as the second article being superior to the first article.

17. An information processing apparatus comprising:
first acquisition means for acquiring first information indicating groups of a plurality of articles;
second acquisition means for acquiring second information indicating purchase histories of the respective articles;
evaluation unit for evaluating, for each group, a relationship between the articles based on the purchase histories of the articles; and
output means for performing output in accordance with the evaluation by the evaluation unit.
